(19) United States
(12) Patent Application Publication
(10) Pub. No.: US 2007/0157264 A1
(43) Pub. Date: Jul. 5, 2007

(54) Method and system for providing a comprehensive integration of transmitted video, interactive television, video on demand and video catalogue services

(76) Inventor: Norton Garfinkle, Boca Raton, FL (US)

Correspondence Address: VENABLE LLP, P.O. BOX 34385, WASHINGTON, DC, 20043-9998, US

(21) Appl. No.: 11/321,536

(22) Filed: Dec. 30, 2005

(51) Int. Cl. H04N 7/16; H04N 7/173

(52) U.S. Cl. 725/88; 725/87; 725/102; 725/135

(57) ABSTRACT

This invention comprises a comprehensive integrated method and system based on a unified hardware and software system whereby users can utilize a computerized catalogue to access and obtain video broadcast program material, can download video content on-demand, can store video content and can engage in a back and forth interactive mode with interactive capable video content.

### FIELD OF THE INVENTION

This invention relates to the management and control of accessing, viewing, and interacting with video content.

### BACKGROUND OF THE INVENTION

The process of finding, accessing, obtaining and interacting with video content has become more difficult in the past decade owing to the proliferation of channels, programs and sources. The viewer is currently overwhelmed with a large number of unorganized options. Increasing user control has been a continuous process in video usage. The remote control device, for example, was a major innovation in this evolution as was the VCR and the DVD player. The efforts to achieve greater control, have focused on increasing the ability of viewers to control:
(a) how they can find what they want to watch
(b) how they can have easy access to all forms of video
(c) when they watch what they have chosen
(d) how they interact with what they watch

The primary object of the present invention is to provide users of video content a more comprehensive, flexible and easy to use method and system that allows increased control over their usage of video and related content.

### DESCRIPTION OF THE PRIOR ART AND SUMMARY OF THE INVENTION

Systems that permit access to video material through data catalogues that list broadcast program material and video content available on demand are well known. The use of Internet Protocol Television (IPTV) has been described (See Optical Networks Daily 28 Nov. 2005 “Interactive Television Networks emerging supplier of IPTV hardware and software to launch in Europe” and see Business Times of Singapore 1 Dec. 2005 “Robert Chua betting on Interactive TV” both of which are incorporated herein by reference.)

There is also prior art that discloses systems for downloading video program material for immediate or subsequent viewing from catalogues and channel listings. A detailed teaching of this concept is provided by the patent to Garfinkle, U.S. Pat. No. 5,530,754 and the patent to LaJoie et al, U.S. Pat. No. 5,850,218 which are incorporated herein by reference. Garfinkle's '754 patent discloses a system in which a catalogue is periodically sent directly to users. LaJoie's Patent uses a central catalogue and a set of predetermined themes which allow the user to access a particular subcatalogue based on one of these themes. This is analogous to picking a page or section from a preprinted catalogue rather than a method for creating a plurality of customizable catalogues as the present invention discloses.

Back and forth interaction between viewers and broadcast TV programming has been known since 1996. A detailed teaching of this concept is provided by patents to Garfinkle, U.S. Pat. No. 5,640,192 and U.S. Pat. No. 5,530,469, to Isono, U.S. Pat. No. 5,363,433 and to Iwafune, U.S. Pat. No. 5,880,720 which are incorporated herein by reference. There are also pending applications by Michael et al, Pub. No. 20020147986, Halgas et al, Pub. No. 20040131335, and Pearson et al, Pub. No. 20020162117 which are incorporated herein by reference. Isono's patent is directed to an information gathering system rather than a method of back and forth interaction. Michael's application is only for a limited communication system to third parties, which can be a useful adjunct to an interactive television system, but is not a comprehensive video content system. Halgas' application is for a system to record interactive television content. This too is useful but is not a comprehensive set of elements that allow for a complete interactive system that includes the ability to access and obtain selected video content from all the available video content. Pearson's invention comprises a means of synchronizing program content and interactive elements. Such a system could be a useful component of an interactive television system but it does not describe a complete interactive system.

The concepts of downloading video and pay-per-view video are well known. Downloading video has been available through such systems as Apple Computer's Music Store and Sony Corporation's web site downloading facility. Detailed teachings of the concept of pay-per-view video are provided by the patent to Morales U.S. Pat. No. 5,291,554 and the patent to Durden et al, U.S. Pat. No. 5,003,384 which are incorporated herein by reference. Both Morales' and Durden's patents teach methods and systems for acquiring pay-per-view video content by electronic distribution.

A detailed teaching of the concept of using a search procedure to create a customized personal television channel is provided by the patent to Wang, U.S. Pat. No. 6,772,147 which is incorporated herein by reference. This patent refers to the ability to create a personal channel containing a line up of programming according to a user's predefined specified parameters. Wang describes a personal viewing channel in which a user has a sequence of predetermined viewing alternatives. This is distinct from the employment of a search engine to create a plurality of customized listings based on search results.

The present invention discloses the ability to create a customized catalogue that enables the user to select from a plurality of content choices that can be watched at any given time. Thus the present invention is analogous to the modern viewing habit of channel surfing as opposed to Wang's method of creating a single channel.

The present invention is directed to a method and system that utilizes an integrated video catalogue that can comprise archived video content and current broadcast content some of which may have interactive capability. The system may be configured to allow the user to create one or more personally customized catalogues. The system may optionally employ a search engine that can search the world wide web and other accessible sources for video program data and content. Search criteria may be user selected or selected by the content provider, or both. For example, a user may create a favorite list that is segregated by movie genres. The user benefits provided by this comprehensive integrated method and system include ease of use, speed of response, breadth of availability and simplicity of use of a single system for these disparate applications.

The method and system that is disclosed herein enables users to engage in interactive television, video on demand and selection of broadcast programming through a unified hardware and software system. Video on demand, interactive television and video catalogue listing services are changing consumer patterns of usage of video content in the United States and elsewhere in the world. Until now, these innovations have traveled on separate paths. There remains a need to integrate these capabilities into a single user friendly method and system. Therefore, an object of this invention is to enable users to access broadcast programs, video on demand content and interactive television program content and to engage in back and forth interactive broadcast program response activities through a single integrated comprehensive system. Another object of this invention is to provide an integrated method and system using such readily available hardware and software capabilities as computers, cell phones, WiFi equipment, television set-top boxes containing signal processors, remote control and other similar devices that enable both direct and interactive real time electronic communication. Another object of this invention is to enable users to utilize an electronic catalogue, an electronic selection procedure and a search engine to efficiently and quickly choose standard broadcast program material, archived video content, interactive program material for viewing and to engage in back and forth interactive communication and response between the viewer and the central system. Another object of this invention is to enable the user not only to obtain data from a comprehensive catalogue of video content, but also to use modem systems such as search technology to create and regularly update customized catalogues so they can find their desired content to watch without having to look haphazardly at hundreds of listings of broadcast channels and an even larger amount of archived video content.

The viewer's access is enhanced by creating a single flexible and easy to use process through which the common methods of delivery of video content (e.g. broadcast, streaming, on-demand, and download) can be accessed. The viewer's control is further enhanced by his or her ability to use a comprehensive, flexible and easy to use system to download and store what the viewer has chosen to watch. The viewer's control is further enhanced by his or her ability to interact with what is watched. Under the method and system of this invention, using the hardware and software for back and forth interactivity empowers the viewer to access and interact with available interactive program material.

This invention integrates multiple hardware and software components into a comprehensive system that: a) enables the user to choose individual video programs from a central catalogue; b) enables users to use a search engine to obtain data from the world wide web based on their preferences; c) enables users to specify, design, and either access or receive or both access and receive customized catalogues based on their specific interests; d) enables the viewer to obtain selected video content either in download, streaming, or standard broadcast mode and in a variety of data formats subject to digital rights management restrictions where applicable; e) enables the viewer to store selected downloaded video content and f) enables the viewer to interact directly or in a bi-directional mode with any video programs which contain interactive elements.

This invention therefore incorporates the use of a comprehensive catalogue that includes information on both scheduled broadcast video and archived video content. The data for each video may include information relating to the production of the video, such as the title, the date, the director, the date of first broadcast, and the actors as well as published summaries, reviews, and other related information. The system optionally incorporates the use of a search engine that enables the user to search the web and other sources for desired video content. The system incorporates the ability to create a plurality of customized catalogues to enable fast and easy selection of both current and archived video material for viewing.

This invention also combines in one comprehensive integrated system the bidirectional capability to send and receive interactive messages related to specific video content together with the capability of actively selecting and passively receiving broadcast content, streaming content, video on demand content and downloaded program content, and other available data. The user benefits provided by this comprehensive integrated method and system include ease of use, speed of response, breadth of availability and simplicity of use of a single system for these disparate applications.

### BRIEF DESCRIPTION OF THE DRAWINGS

FIG. 1 is a flowchart that shows the steps of the method according to a first embodiment of the invention.

FIG. 2 shows the steps of an alternative embodiment of the invention.

FIG. 3 is a schematic depiction of the general structure of the first preferred embodiment.

FIG. 4 depicts a user's options and actions when dealing with the central catalogue or a customized catalogue in an exemplary embodiment of the device.

FIG. 5 shows the processing of interactive television commands from the user's control.

FIG. 6 shows the interaction of the central computer system and the individual computer system in the creation of custom catalogues and searches.

### DETAILED DESCRIPTIONS OF PREFERRED EMBODIMENTS OF THE INVENTION

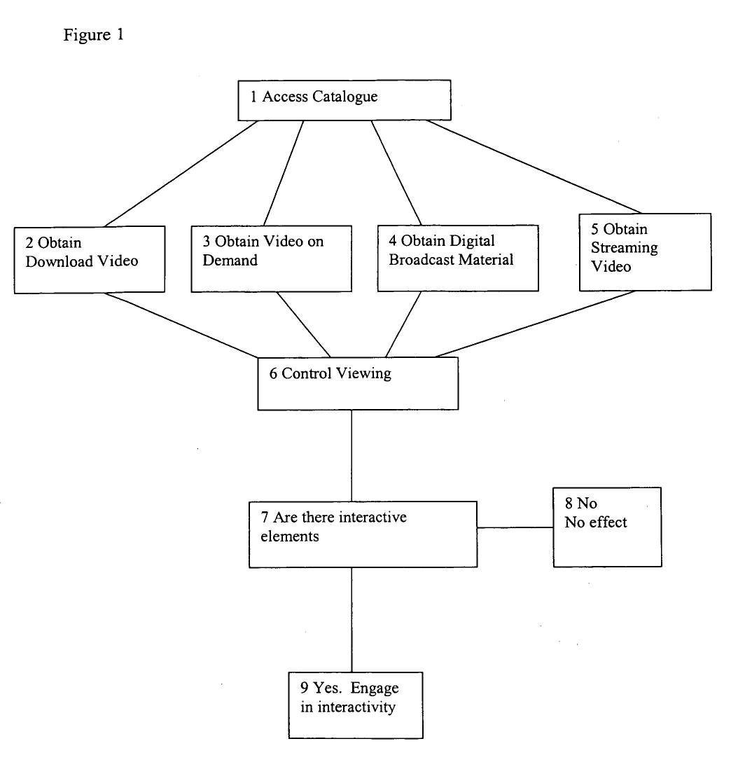

Now referring to FIG. 1, this figure describes the user accessing a central catalogue in step 1, using the catalog to obtain Download Video in step 2, Video on Demand in step 3, Digital Broadcast material in step 4 or Streaming video in step 5. Subsequently the viewing is controlled by the viewer's individual computer capable system or device in step 6. If the video has interactive elements as in step 7, the viewer can interact with them in step 9.

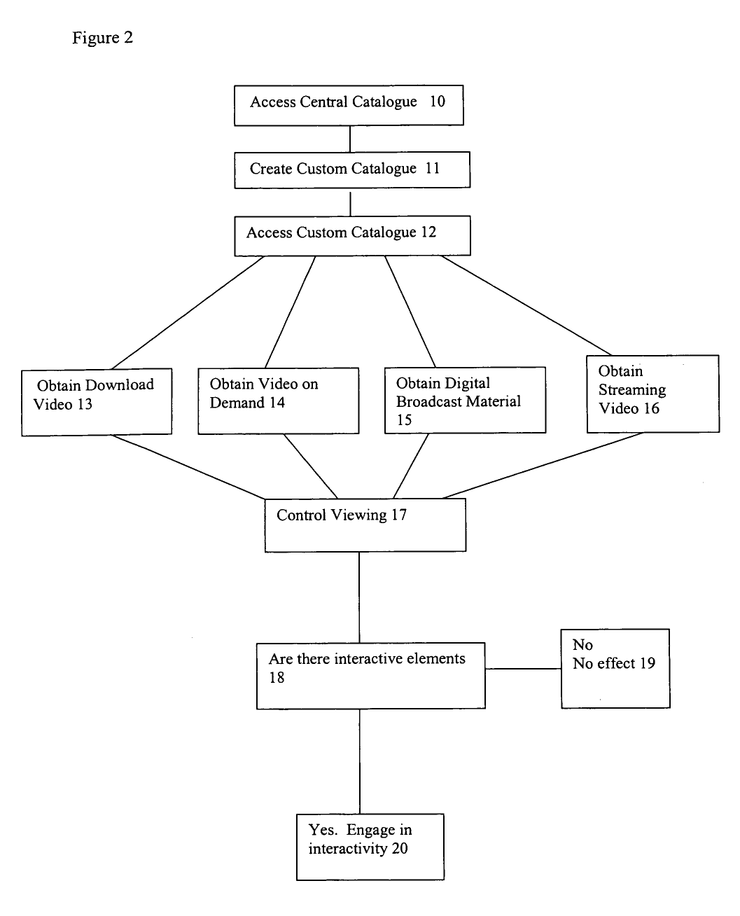

Referring to FIG. 2, in this embodiment the central catalogue is accessed in step 10. The central catalogue consists of a listing of content related data that is available to all viewers from a video content provider. Next, in step 11 a customized catalogue is created by the user from the central catalogue and other sources including the world wide web. The customized catalogue is stored, and the viewer accesses the customized catalogue 12 to obtain either, Download Video Content 13, Video on Demand content 14, Digital Broadcast Video content 15, Streaming Video content 16. The video is controlled by the viewer's computer capable individual system or device 17. If the video has interactive elements 18, the viewer can interact with them (20) using interactive software.

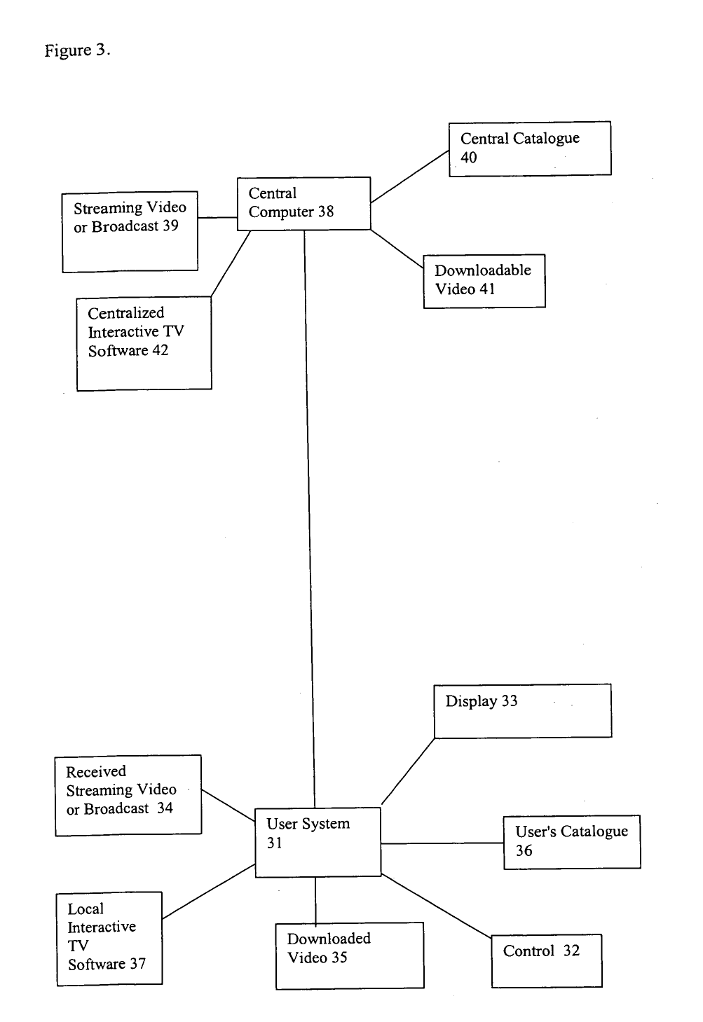

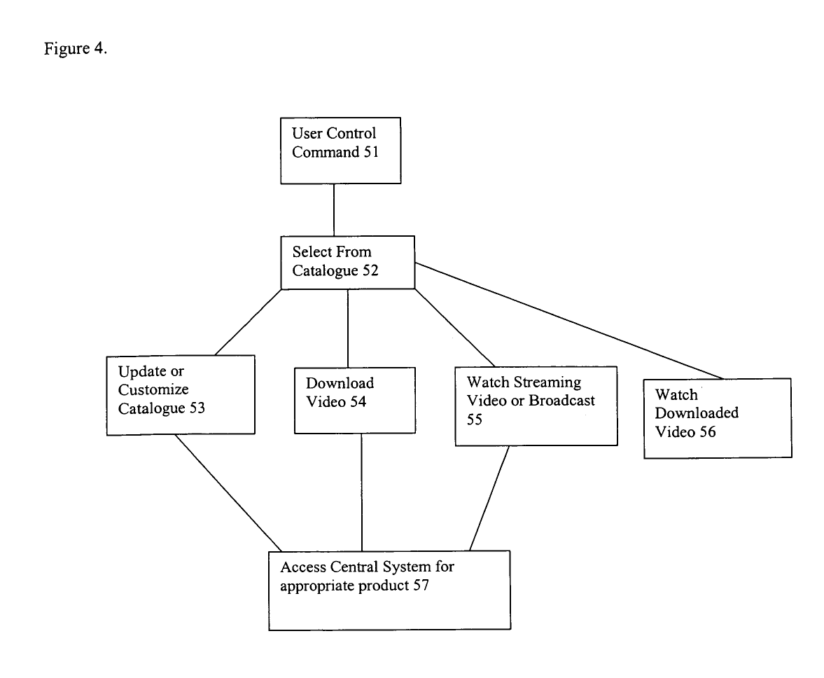

Now referring to FIG. 3, the system includes the user's system 31 that includes a control 32 as described in FIG. 4, a display for display of video and other selected content 33 a processor, and a memory. The user's system receives and displays any streaming or broadcast video 34, and can store in memory any downloaded video 35. The user's system can also contains in memory a user's customized catalogue if one is constructed or requested by the user 36 and any necessary local user interaction software 37 for controlling the system. The user's system is connected by standard telecommunications methods to the central computer system 38 which can provide broadcast and streaming channels 39. The central system also has stored in its memory a central catalogue 40, video content that includes downloadable video content 41, and central interaction software 42.

FIG. 4 shows the user control including the options and actions when dealing with the central catalogue or a customized catalogue. The user issues a command 51 to call up either the central catalogue or customized catalogue on the user's screen. The user can then select 52 among a set of options including: update or reconfigure the customized catalogue 53; download a video 54. The user can then watch a streaming or broadcast program 55, watch a video stored on the users system or on any device plugged into the system—such as an external hard drive or iPod 56 which may include personal video content or other image content. In the case of the content identified by reference numerals 53, 54, or 55, a signal is then sent to the central computer 57 to process the request. In the case of content identified by reference numeral 56 the content is simply shown.

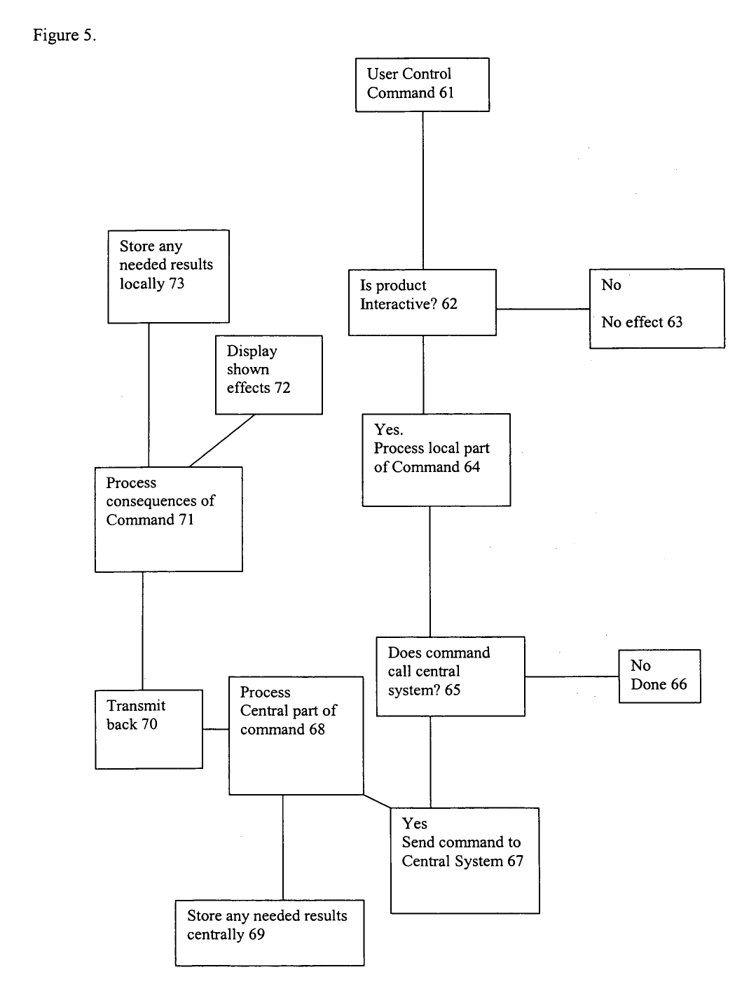

FIG. 5 shows the processing of interactive television commands from the user's control. Either self-generated or in response to an embedded interactive element, the user issues a control command 61. In the case of preferred embodiment 1, the user's system then checks to see if what is being displayed is a program with interactive elements in step 62. If the selected program has interactive elements the user's system processes the local part of the command in step 64. It then checks to see if any part of the command requires communication with the central system in step 65. If not it sends no signal 66. If yes it sends whatever information is needed to the central system at step 67 which then processes the command as needed in step 68. If the central system needs to store any result from this it does so in step 69. If it needs to send back any information to the user's system it does so in step 70. Using the local and central results the user's system executes any final processing of consequences in step 71. The user's system then displays any consequences that should be displayed 72 and stores locally any data that should be stored 73.

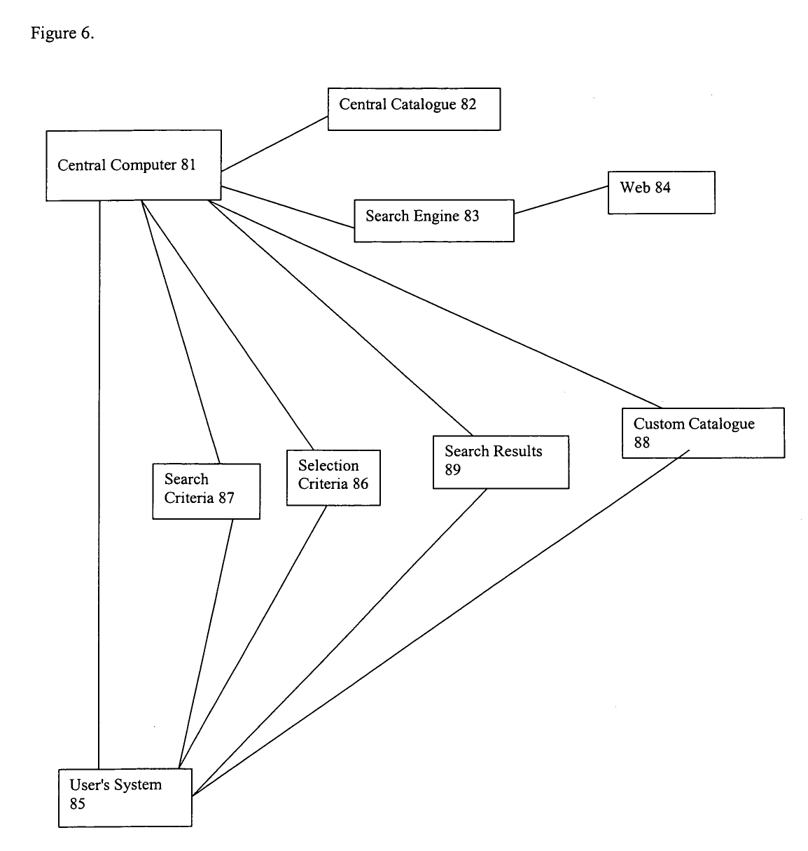

FIG. 6 shows methods whereby the user can access those videos or channels he or she wants to watch. The central system 81 contains a central catalogue 82. Central system 81 may also include a search engine 83 capable of searching its own catalogued material and may also be capable of searching material from the World Wide Web 84. The user's system 85 includes the ability for the user to create one or more sets of custom selection criteria for going through the central catalogue 86 and/or search criteria 87 for using the search engine. The user sends the selection criteria to the central system which responds with a custom catalogue 88 of video content for the user to select from. This process of sending the custom catalogue to the user's system can either be user initiated or set to happen at periodic time intervals so that the customized catalogue can be automatically updated according to the selection criteria. If there is a search engine associated with the central system, the user may also enter search criteria 87 which are then sent to the central system which enters them in the search engine and produces a listing of search results consisting of videos available on other systems for the user to watch or download 89.

The first preferred embodiment uses a television set, a computer enabled signal processor, and a remote control that together contain all the needed local hardware and the local software. This system would connect either by cable or satellite dish or telephone wires or the internet to the central system. The central system would have on it a central catalogue and optionally, a search engine. Using their controllers the viewers at home can, by pressing a button, create a customized catalogue, access either the full central catalogue or a customized catalogue or use a search engine to access listings from the World Wide Web and other available sources.

A user choosing to create a customized catalogue would be able to utilize a plurality of selection criteria, some as predetermined options and others which they would personally define. By using one or more of these criteria, the user would be able to create a customized catalogue using such criteria as the works of a particular producer or director, or featuring particular actors, or created in particular years, or recommended by specific professional or amateur critics, or a plurality of other criteria. The catalogue could incorporate archived as well as current video. The user could also save this catalogue on his or her home system. The user's system or the central system or both systems could optionally contain software to periodically update such catalogues.

By standard point and click methods the viewer would make a selection of content to be watched from the central catalogue, any of his or her customized catalogues or from a search result. If the selection is for a broadcast or streaming transmission the television set would shift to that channel. If the selection is for a download, the selection would be downloaded to the user's system or to an adjunct memory capable device connected to the system.

1. An integrated method to enable a plurality of users to access, control, and interact with their choices of video program material including the steps of:
accessing a comprehensive catalogue of video program material,
searching the data in said catalogue for information relating to video program material,
obtaining downloaded video program material comprising either, video on demand program material, digital broadcast program material, or streaming program material, and
controlling their viewing of the program material they obtain by allowing for the initiation and pausing of said video content.

2. The method as in claim 1 that establishes a limit of any kind to the use of the program material obtained.

3. The method recited in claim 1 further comprising engaging interactively with a plurality of program material configured for back and forth response between viewers and a central system managing the interactive features of the program material.

4. The method recited in claim 2 further comprising engaging interactively with a plurality of program material configured for back and forth response between viewers and a central system managing the interactive features of the program material.

5. The method as in claim 1 in which users can:
access a central system catalogue that can include alone or in combination: current video program material; recently released video program material; archival video content, and
create or receive one or more catalogues of video material customized to their own specifications, and
access their customized catalogues to obtain individual programs or a plurality of video program material.

6. The method as in claim 2 in which users can:
access a central system catalogue that can include alone or in combination: current video program material; recently released video program material; archival video content, and
create or receive one or more catalogues of video material customized to their own specifications, and
access their customized catalogues to obtain individual programs or a plurality of video program material.

7. The method as in claim 3 in which users can:
access a central system catalogue that can include alone or in combination: current video program material; recently released video program material; archival video content, and
create or receive one or more catalogues of video material customized to their own specifications, and
access their customized catalogues to obtain individual programs or a plurality of video program material.

8. The method as in claim 4 in which users can:
access a central system catalogue that can include alone or in combination: current video program material; recently released video program material; archival video content, and
create or receive one or more catalogues of video material customized to their own specifications, and
access their customized catalogues to obtain individual programs or a plurality of video program material.

9. The method as in claim 1 in which the user can communicate with other users and with the central computer system using voice over internet protocol or cell phone voice communication or wired telephone voice communication.

10. The method as in claim 2 in which the user can communicate with other users and with the central computer system using voice over internet protocol or cell phone voice communication or wired telephone voice communication.

11. The method as in claim 3 in which the user can communicate with other users and with the central computer system using voice over internet protocol or cell phone voice communication or wired telephone voice communication or e-mail or instant messaging.

12. The method as in claim 4 in which the user can communicate with other users and with the central computer system using voice over internet protocol or cell phone voice communication or wired telephone voice communication or e-mail or instant messaging.

13. The method as in claim 5 in which the user can communicate with other users and with the central computer system using voice over internet protocol or cell phone voice communication or wired telephone voice communication or e-mail or instant messaging.

14. The method as in claim 6 in which the user can communicate with other users and with the central computer system using voice over internet protocol or cell phone voice communication or wired telephone voice communication or e-mail or instant messaging.

15. The method as in claim 7 in which the user can communicate with other users and with the central computer system using voice over internet protocol or cell phone voice communication or wired telephone voice communication or e-mail or instant messaging.

16. The method as in claim 8 in which the user can communicate with other users and with the central computer system using voice over internet protocol or cell phone voice communication or wired telephone voice communication or e-mail or instant messaging.

17. A system that allow a plurality of users to interact with video availability listings, to obtain broadcast video content, video on demand content and engage interactively back and forth with television or other broadcast programming, comprising in combination:
a central computer system,
a catalogue stored on said central computer system listing streaming video programming, broadcast video programming, downloadable video, interactive television programs, interactive program channels, and other available content,
software and hardware on the central computer system for communication with the plurality of user systems,
a plurality of individual computer systems: personal computers or computer capable signal processors or computer capable cell phones, or PDAs, or other equipment connected to said central computer system by commonly available communications means either directly or through the internet by means of digital cable or DSL lines or telephone lines or WiFi systems, or other communications hardware
display devices for the plurality of systems:WiFi device or a cell phones or computer screens or television screens or other display devices to receive the input from the central computer system or from a broadcast network,
input devices: WiFi devices or remote control devices or cell phones or a standard computer input devices: keyboards or mice or touch pads or other input devices or any combination thereof,
communications devices and software for allowing the user to receive output communications from the central computer system,
software on the plurality of computer systems allowing for the download or storage or display of the catalogue, or any combination thereof,
software on the plurality of computer systems allowing the user to make selections from the catalogue,
one or more input devices to control the selection software,
software on the plurality of individual computer systems allowing for the download, storage, or display of video content, or any combination thereof,
software on the individual computer systems enabling the user to interact with television programs by sending signals back to the central computer, and
software parameters and routines in the central computer to calculate individual and aggregate data derived from responses to interactive television commands.

18. The system as in claim 17 which has the capability to transmit to a user or a plurality of users directly to one or more of each user's computer system devices for viewing, or storage or display or any combination thereof, of data calculated by the central computer based on the responses of the user or a plurality of users or both to interactive television commands.

19. The system as in claim 17 which further incorporates;
software on the central computer system, or on the plurality of individual computer systems or both enabling the creation of customized catalogues,
software on the plurality of individual computer systems allowing for the download or display or both of a customized catalogue, and
software on the plurality of individual computer systems allowing the user to make selections from one or more customized catalogues.

20. The system as in claim 18 which further incorporates:
software on the central computer system, or on the plurality of individual computer systems or both enabling the creation of customized catalogues,
software on the plurality of individual computer systems allowing for the download or display or both of a customized catalogue, and
software on the plurality of individual computer systems allowing the user to make selections from one or more customized catalogues.

21. The system as in claim 17 which acquires data through a search engine optionally accessed through a web browser.

22. The system as in claim 18 which acquires data through a search engine optionally accessed through a web browser.

23. The system as in claim 19 which acquires data through a search engine optionally accessed through a web browser.

24. The system as in claim 20 which acquires data through a search engine optionally accessed through a web browser.

25. The system as in claim 17 that includes a sub-system that establishes a limit of any kind to the use of downloaded or stored video content including but not restricted to such means as preventing duplication of the content or blocking access to such content if said limit for authorized viewing has been exceeded.

26. The system as in claim 18 that includes a sub-system that establishes a limit of any kind to the use of downloaded or stored video content including but not restricted to such means as preventing duplication of the content or blocking access to such content if said limit for authorized viewing has been exceeded.

27. The system as in claim 19 that includes a sub-system that establishes a limit of any kind to the use of downloaded or stored video content including but not restricted to such means as preventing duplication of the content or blocking access to such content if said limit for authorized viewing has been exceeded.

28. The system as in claim 20 that includes a sub-system that establishes a limit of any kind to the use of downloaded or stored video content including but not restricted to such means as preventing duplication of the content or blocking access to such content if said limit for authorized viewing has been exceeded.

29. The system as in claim 21 that includes a sub-system that establishes a limit of any kind to the use of downloaded or stored video content including but not restricted to such means as preventing duplication of the content or blocking access to such content if said limit for authorized viewing has been exceeded.

30. The system as in claim 22 that includes a sub-system that establishes a limit of any kind to the use of downloaded or stored video content including but not restricted to such means as preventing duplication of the content or blocking access to such content if said limit for authorized viewing has been exceeded.

31. The system as in claim 23 that includes a sub-system that establishes a limit of any kind to the use of downloaded or stored video content including but not restricted to such means as preventing duplication of the content or blocking access to such content if said limit for authorized viewing has been exceeded.

32. The system as in claim 24 that includes a sub-system that establishes a limit of any kind to the use of downloaded or stored video content including but not restricted to such means as preventing duplication of the content or blocking access to such content if said limit for authorized viewing has been exceeded.

33. The system as in claim 17 where the individual computer capabilities are contained in two distinct and severable systems: a first computer system that includes a video signal processor and a second separate computer system which performs the principal interactive TV functions.

34. The system as in claim 18 where the individual computer capabilities are contained in two distinct and severable systems: a first computer system or computer capable television signal processor and a second separate computer system that includes hardware and software to perform the principal interactive TV functions.

35. The system as in claim 19 where the individual computer capabilities are contained in two distinct and severable systems: a first computer system or computer capable television signal processor and a second separate computer system that includes hardware and software to perform the principal interactive TV functions.

36. The system as in claim 20 where the individual computer capabilities are contained in two distinct and severable systems: a first computer system or computer capable television signal processor and a second separate computer system that includes hardware and software to perform the principal interactive TV functions.

37. The system as in claim 21 where the individual computer capabilities are contained in two distinct and severable systems: a first computer system or computer capable television signal processor and a second separate computer system that includes hardware and software to perform the principal interactive TV functions.

38. The system as in claim 22 where the individual computer capabilities are contained in two distinct and severable systems: a first computer system or computer capable television signal processor and a second separate computer system that includes hardware and software to perform the principal interactive TV functions.

39. The system as in claim 23 where the individual computer capabilities are contained in two distinct and severable systems: a first computer system or computer capable television signal processor and a second separate computer system that includes hardware and software to perform the principal interactive TV functions.

40. The system as in claim 24 where the individual computer capabilities are contained in two distinct and severable systems: a first computer system or computer capable television signal processor and a second separate computer system that includes hardware and software to perform the principal interactive TV functions.

41. The system as in claim 25 where the individual computer capabilities are contained in two distinct and severable systems: a first computer system or computer capable television signal processor and a second separate computer system that includes hardware and software to perform the principal interactive TV functions.

42. The system as in claim 26 where the individual computer capabilities are contained in two distinct and severable systems: a first computer system or computer capable television signal processor and a second separate computer system that includes hardware and software to perform the principal interactive TV functions.

43. The system as in claim 27 where the individual computer capabilities are contained in two distinct and severable systems: a first computer system or computer capable television signal processor and a second separate computer system that includes hardware and software to perform the principal interactive TV functions.

44. The system as in claim 28 where the individual computer capabilities are contained in two distinct and severable systems: a first computer system or computer capable television signal processor and a second separate computer system that includes hardware and software to perform the principal interactive TV functions.

45. The system as in claim 29 where the individual computer capabilities are contained in two distinct and severable systems: a first computer system or computer capable television signal processor and a second separate computer system that includes hardware and software to perform the principal interactive TV functions.

46. The system as in claim 30 where the individual computer capabilities are contained in two distinct and severable systems: a first computer system or computer capable television signal processor and a second separate computer system that includes hardware and software to perform the principal interactive TV functions.

47. The system as in claim 31 where the individual computer capabilities are contained in two distinct and severable systems a first computer system or computer capable television signal processor and a second separate computer system that includes hardware and software to perform the principal interactive TV functions.

48. The system as in claim 32 where the individual computer capabilities are contained in two distinct and severable systems: a first computer system or computer capable television signal processor and a second separate computer system that includes hardware and software to perform the principal interactive TV functions.
